(19) United States
(12) Patent Application Publication
(10) Pub. No.: US 2022/0284610 A1
(43) Pub. Date: Sep. 8, 2022

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventors: KATSUHISA ITO, TOKYO (JP); KENGO HAYASAKA, TOKYO (JP)

(21) Appl. No.: 17/597,404

(22) PCT Filed: Jun. 12, 2020
(86) PCT No.: PCT/JP2020/023161

§ 371 Date: Jan. 5, 2022

(30) Foreign Application Priority Data
Jul. 17, 2019 (JP) 2019-132179

(51) Int. Cl. G06T 7/55

(52) U.S. Cl. CPC G06T 7/55; G06T 2207/30241

(57) ABSTRACT

An information processing apparatus (1, 2) according to the present disclosure includes a control unit (40). The control unit (40) selects a correction target region and a reference region around the correction target region on the basis of a depth map relating to depth information of a subject space. The control unit (40) corrects the depth information of the correction target region on the basis of a distance between the correction target region and the reference region in the subject space.

### FIELD

The present disclosure relates to an information processing apparatus, an information processing method, and an information processing program.

### BACKGROUND

A technology of calculating a depth of a subject space using a plurality of images having different viewpoints is known. In such a technology, for example, a depth value (depth) in each pixel of an image is calculated using block matching (stereo matching) (for example, refer to Patent Literature 1).

### CITATION LIST

### Patent Literature

Patent Literature 1: JP 2011-171858 A

### SUMMARY

### Technical Problem

However, in the above-described technology in the related art, for example, a depth having a large luminance change as compared with surrounding pixels, such as an edge, can be calculated with high accuracy, but there is a problem that calculation accuracy becomes low for a depth of a pixel having a small luminance change.

Therefore, the present disclosure proposes an information processing apparatus, an information processing method, and an information processing program capable of improving calculation accuracy of depth information.

### Solution to Problem

An information processing apparatus according to the present disclosure includes a control unit. The control unit selects a correction target region and a reference region around the correction target region on the basis of a depth map relating to depth information of a subject space. The control unit corrects the depth information of the correction target region on the basis of a distance between the correction target region and the reference region in the subject space.

### BRIEF DESCRIPTION OF DRAWINGS

FIG. 1 is a diagram for describing an outline of image processing according to a first embodiment of the present disclosure.

FIG. 2 is a diagram illustrating a configuration example of an image processing apparatus according to the first embodiment of the present disclosure.

FIG. 3 is a diagram illustrating an example of a reference image.

FIG. 4 is a diagram illustrating an example of a depth map.

FIG. 5 is a diagram for describing selection of a pixel by a pixel selection unit.

FIG. 6 is a table illustrating each piece of information of surrounding pixels.

FIG. 7 is a diagram for describing a total value in a case where a disparity value of a correction target pixel is changed.

FIG. 8 is a graph illustrating an example of a relationship between a disparity value of a correction target pixel and a total value.

FIG. 9 is a diagram illustrating an example of a corrected depth map.

FIG. 10 is a flowchart illustrating a flow of processing according to the first embodiment of the present disclosure.

FIG. 11 is a diagram illustrating a configuration example of an image processing apparatus according to a second embodiment of the present disclosure.

FIG. 12 is a diagram (1) for describing a reason why an adjustment unit performs adjustment.

FIG. 13 is a diagram (2) for describing a reason why the adjustment unit performs adjustment.

FIG. 14 is a diagram for describing an adjustment method by the adjustment unit.

FIG. 15 is a flowchart illustrating a flow of processing according to the second embodiment of the present disclosure.

FIG. 16 is a hardware configuration diagram illustrating an example of a computer that implements functions of the image processing apparatus.

### DESCRIPTION OF EMBODIMENTS

Hereinafter, embodiments of the present disclosure will be described in detail with reference to the drawings. Note that, in the following embodiments, the same parts are denoted by the same reference numerals, and redundant description will be omitted.

In addition, the present disclosure will be described according to the following item order.

1. First Embodiment

1-1. Outline of information processing according to first embodiment

1-2. Configuration of information processing apparatus according to first embodiment

1-3. Procedure of information processing according to first embodiment

2. Second Embodiment

2-1. Configuration of information processing apparatus according to second embodiment

2-2. Procedure of information processing according to second embodiment

3. Other configuration examples

4. Effects of information processing apparatus according to present disclosure

5. Hardware configuration

### 1. First Embodiment

### 1-1. Outline of Information Processing According to First Embodiment

An image processing apparatus according to a first embodiment of the present disclosure is an apparatus that generates a depth map on the basis of an image captured by, for example, a stereo camera or a multi-eye camera. The image processing apparatus according to the first embodiment corrects a depth map of a subject space generated on the basis of a plurality of images captured from different viewpoints by using pixels with high depth calculation accuracy. As a result, it is possible to realize high accuracy of applications such as foreground or background extraction, and refocusing processing using the depth map.

The technology (hereinafter, referred to as the present technology) described in the present embodiment is a technology of correcting an output result calculated on the basis of comparison of image signals represented by template matching or the like. More specifically, the present technology is a technology of correcting depth information for a pixel which has a luminance change smaller than that of surrounding pixels and for which the depth information cannot be generated accurately.

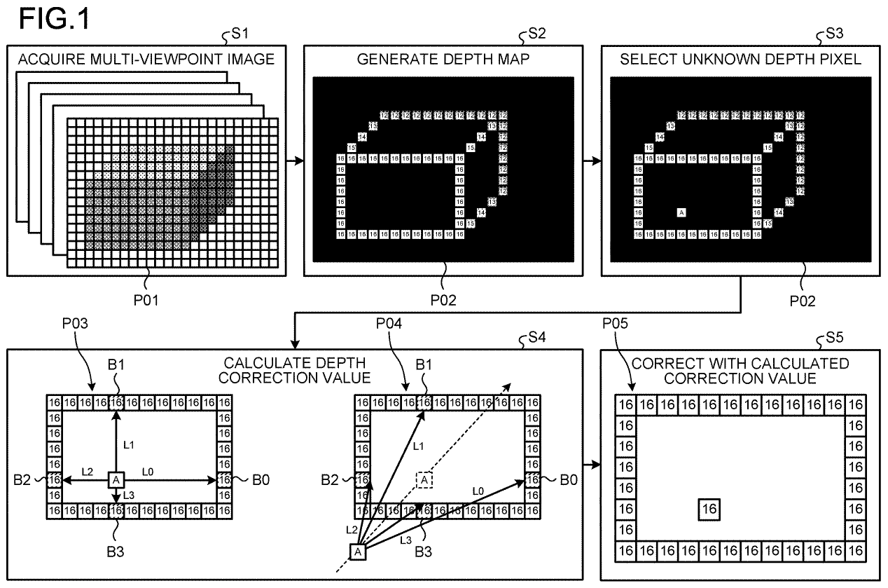

Hereinafter, an outline of image processing performed by an image processing apparatus 1 (illustration is omitted in FIG. 1) will be described with reference to FIG. 1. FIG. 1 is a diagram for describing the outline of the image processing according to the first embodiment of the present disclosure.

Note that, in the following description, unless otherwise specified, a lateral direction (horizontal direction) of an image is set as an x direction, and a longitudinal direction (vertical direction) is set as a y direction.

The image processing according to the present disclosure is performed by the image processing apparatus 1. The image processing apparatus 1 is an information processing apparatus that executes image processing according to the present disclosure, and is, for example, a server device, a personal computer (PC), or the like. Note that the image processing apparatus 1 may be mounted on a camera.

The image processing apparatus 1 acquires, for example, a plurality of images (multi-viewpoint images) captured from different viewpoints (step S1). FIG. 1 illustrates a reference image P01 as a reference for creating a depth map among a plurality of images acquired by the image processing apparatus 1.

The image processing apparatus 1 generates a depth map P02 of a subject space using the acquired multi-viewpoint images (step S2). The image processing apparatus 1 generates a disparity map as the depth map P02 by using, for example, a block matching method. The image processing apparatus 1 calculates a phase difference (disparity) between the reference image P01 and a comparison image by using the reference image P01 as a reference for generating the depth map P02 and the comparison image, among the multi-viewpoint images. Specifically, the image processing apparatus 1 calculates a correlation value of a unit region between the comparison image and the reference image P01 while sequentially moving a local region (unit region) of the comparison image in the horizontal or vertical direction. The image processing apparatus 1 calculates, as the phase difference, a positional deviation (pixel shift, disparity) of a unit region with the strongest correlation (having the largest correlation value) within a comparison range between the comparison image and the reference image P01. Note that the moving direction of the local region is not limited to the horizontal or vertical direction, and may be any direction such as an oblique direction, for example.

As illustrated in FIG. 1, the image processing apparatus 1 generates the depth map P02 having a disparity value (disparity) for each pixel. At this time, for example, the image processing apparatus 1 generates the depth map P02 as an unknown depth pixel, without calculating a disparity value for a pixel of which the calculated correlation value is equal to or less than a predetermined threshold, considering that the calculation accuracy of the disparity value is low. In the example illustrated in FIG. 1, a numerical value displayed in each pixel represents a disparity value, and an unknown depth pixel is illustrated in black without displaying a numerical value. Here, as illustrated in FIG. 1, it is assumed that the disparity value becomes smaller as the pixel of a subject is closer to the back side, and the disparity value becomes larger as the pixel of the subject is closer to the front side.

Note that, here, the image processing apparatus 1 generates the depth map P02 using the multi-viewpoint image, but the present disclosure is not limited thereto. For example, the image processing apparatus 1 may generate the depth map P02 from the stereo images. Alternatively, the image processing apparatus 1 may generate a distance map as the depth map P02 by calculating a disparity amount by the block matching method and calculating a distance to the subject by the principle of triangulation on the basis of the calculated disparity amount.

Subsequently, the image processing apparatus 1 corrects the generated depth map P02. First, the image processing apparatus 1 selects the unknown depth pixel as a correction target (step S3). In the example illustrated in FIG. 1, the image processing apparatus 1 selects a pixel A as the unknown depth pixel as the correction target.

Next, the image processing apparatus 1 calculates a depth correction value (step S4). As illustrated in a partial region P03 in FIG. 1, first, the image processing apparatus 1 selects pixels (hereinafter, also referred to as surrounding pixels) B0 to B3 that are present around the unknown depth pixel A and have depth information. Note that, here, partial regions P03 to P05 are obtained by enlarging a part of the depth map P02 and displaying the unknown depth pixels in white in order to make the depth map P02 in FIG. 1 easily viewable.

The image processing apparatus 1 calculates a correction value of the unknown depth pixel A on the basis of a total value Lₜₒₜₐₗ (Lₜₒₜₐₗ=L0+L1+L2+L3) of distances L0 to L3 between the pixel A and the surrounding pixels B0 to B3 when the depth of the pixel A in the subject space is changed.

For example, in the partial region P03, an example is illustrated in which the total value Lₜₒₜₐₗ is calculated with the depth of the pixel A in the subject space as the same depth as the surrounding pixels B0 to B3. In addition, in the partial region P04, an example is illustrated in which the total value Lₜₒₜₐₗ is calculated assuming that the depth of the pixel A in the subject space is closer to the front side than the surrounding pixels B0 to B3.

Here, for example, in a case where the unknown depth pixel is surrounded by the pixels B0 to B3 having the depth information, it is considered that the unknown depth pixel A is on the same plane as the pixels B0 to B3 having the depth information. In other words, it can be considered that the inside of a closed space configured by a plurality of pixels having depth information is configured by one plane.

The total value Lₜₒₜₐₗ of the distances L0 to L3 in a case where the depth of the pixel A is on the same plane as the surrounding pixels B0 to B3 (refer to the partial region P03) is smaller than the total value Lₜₒₜₐₗ of the distances L0 to L3 in a case where the pixel A is not on the same plane as the surrounding pixels B0 to B3 (refer to the partial region P04). In other words, in a case where the total value Lₜₒₜₐₗ is calculated by changing the depth of the pixel A, the total value Lₜₒₜₐₗ is the smallest in a case where the pixels A and B0 to B3 are on the same plane.

Therefore, the image processing apparatus 1 calculates the total value Lₜₒₜₐₗ of the distances L0 to L3 between the pixel A and the surrounding pixels B0 to B3 while changing the depth of the pixel A. The image processing apparatus 1 calculates the correction value of the pixel A according to the calculated total value Lₜₒₜₐₗ For example, the image processing apparatus 1 determines the disparity of the pixel A in a case where the calculated total value Lₜₒₜₐₗ is minimum, as the correction value of the pixel A.

Subsequently, the image processing apparatus 1 corrects the depth information of the pixel A with the calculated correction value (step S5). In the example illustrated in the partial region P05 in FIG. 1, the image processing apparatus 1 corrects the disparity of the unknown depth pixel A to “16”, which is the same as the disparity of the surrounding pixels B0 to B3. The image processing apparatus 1 similarly corrects other unknown depth pixels.

As described above, the image processing apparatus 1 calculates the distances between the pixel A and the surrounding pixels B0 to B3 while changing the depth of the unknown depth pixel A, and corrects the depth information (disparity) of the unknown depth pixel A according to the calculated distance. As a result, the image processing apparatus 1 can correct the depth information of the pixel of which the depth is unknown, that is, the calculation accuracy of the disparity is low, and can improve the calculation accuracy of the depth information.

### 1-2. Configuration of Information Processing Apparatus According to First Embodiment

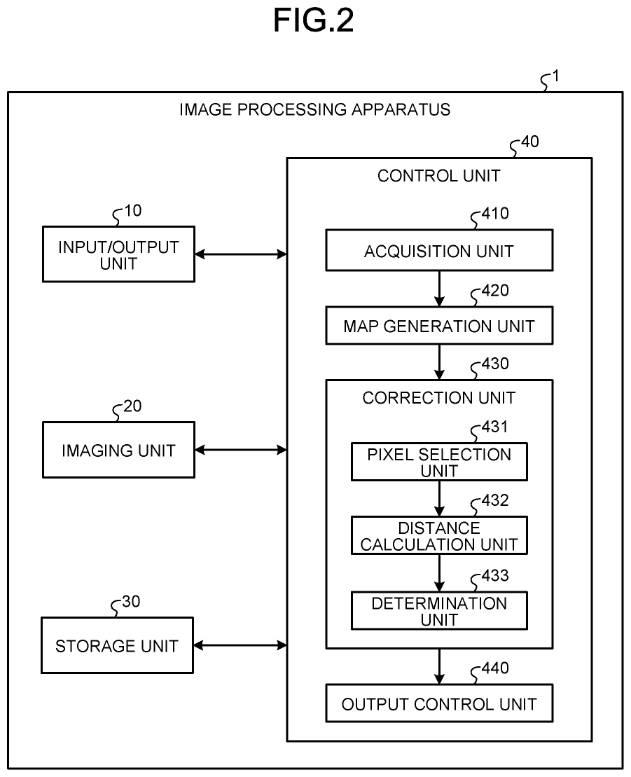

A configuration of the image processing apparatus 1 will be described with reference to FIG. 2. FIG. 2 is a diagram illustrating a configuration example of the image processing apparatus 1 according to the first embodiment of the present disclosure. Specific examples of the image processing apparatus 1 include a mobile phone, a smart device (smartphone or tablet), a camera (for example, a digital still camera or a digital video camera), a personal digital assistant (PDA), and a personal computer. Note that the image processing apparatus 1 may be a car navigation apparatus, a head-up display, a navigation display, a machine to machine (M2M) device, or an Internet of Things (IoT) device. The image processing apparatus 1 may be an apparatus (for example, an image processing processor) mounted on these apparatuses.

In addition, the image processing apparatus 1 may be an apparatus mounted on a moving body. At this time, the image processing apparatus 1 may be an apparatus constituting a part of a system (for example, an automatic brake system (also referred to as a collision avoidance system, a collision damage reduction system, or an automatic stop system.), a danger detection system, a tracking system, a car navigation system, or the like) that supports steering (driving) of the moving body, or may be an apparatus constituting a part of a system (for example, an automatic driving system) that controls autonomous traveling of the moving body. Needless to say, the image processing apparatus 1 may simply be an apparatus constituting a part of a system that controls traveling of the moving body. Note that the image processing apparatus 1 may be a system itself that supports steering (driving) of the moving body, or may be a system itself that controls autonomous traveling of the moving body. Needless to say, the image processing apparatus 1 may be a system itself that controls traveling of the moving body. In addition, the image processing apparatus 1 may be a moving body itself.

Here, the moving body may be a moving body (for example, a vehicle such as an automobile, a bicycle, a bus, a truck, a motorcycle, a train, or a linear motor car) that moves on land (on the ground in a narrow sense) or may be a moving body (for example, the subway) that moves in the ground (for example, in the tunnel). In addition, the moving body may be a moving body (for example, a ship such as a passenger ship, a cargo ship, or a hovercraft) that moves over water or a moving body (for example, a submersible ship such as a submarine, an underwater craft, or an unmanned submersible) that moves under water. Furthermore, the moving body may be a moving body (for example, an aircraft such as an airplane, an airship, or a drone) that moves in the atmosphere or a moving body (for example, a spacecraft such as an artificial satellite, a spaceship, a space station, or a probe) that moves outside the atmosphere.

Note that the concept of an aircraft includes not only a heavy aircraft such as an airplane or a glider but also a light aircraft such as a balloon or an airship. In addition, the concept of an aircraft includes not only a heavy aircraft and a light aircraft but also a rotorcraft such as a helicopter or an autogyro. Note that the aircraft station device (alternatively, an aircraft on which an aircraft station device is mounted) may be an unmanned aircraft such as a drone.

Note that the image processing apparatus 1 is not limited to a system that controls autonomous traveling of a device moving body constituting a part or all of a system that supports traveling of a moving body, and may be, for example, an apparatus constituting a part or all of a system intended for surveying and monitoring.

As illustrated in FIG. 2, the image processing apparatus 1 includes an input/output unit 10, an imaging unit 20, a storage unit 30, and a control unit 40. Note that the configuration illustrated in FIG. 2 is a functional configuration, and the hardware configuration may be different from the functional configuration. In addition, the functions of the image processing apparatus 1 may be implemented in a distributed manner in a plurality of physically separated apparatuses.

(Input/Output Unit)

The input/output unit 10 is a user interface for exchanging information with a user. For example, the input/output unit 10 is an operation device for the user to perform various operations, such as a keyboard, a mouse, an operation key, and a touch panel. Alternatively, the input/output unit 10 is a display device such as a liquid crystal display or an organic electroluminescence display (organic EL display). The input/output unit 10 may be an acoustic device such as a speaker or a buzzer. In addition, the input/output unit 10 may be a lighting device such as a light emitting diode (LED) lamp. The input/output unit 10 functions as input/output means (input means, output means, operation means, or notification means) of the image processing apparatus 1.

The input/output unit 10 may be a communication interface for communicating with another device. At this time, the input/output unit 10 may be a network interface or a device connection interface. For example, the input/output unit 10 may be a local area network (LAN) interface such as a network interface card (NIC), or may be a universal serial bus (USB) interface including a USB host controller and a USB port. Note that the input/output unit 10 may be a wired interface or a wireless interface. The input/output unit 10 functions as communication means of the image processing apparatus 1. The input/output unit 10 communicates with another device under the control of the control unit 40.

(Imaging Unit)

The imaging unit 20 is, for example, a camera including an image sensor that images an object. The imaging unit 20 may be a camera capable of capturing a still image or a camera capable of capturing a moving image. The imaging unit 20 is, for example, a multi-eye camera or a stereo camera. Note that the imaging unit 20 may be a monocular camera. The imaging unit 20 may include an image sensor in which image plane phase difference pixels are discretely embedded. Alternatively, the imaging unit 20 may be a distance measurement sensor that measures a distance to a subject, such as a time of flight (ToF) sensor. The imaging unit 20 functions as imaging means of the image processing apparatus 1.

(Storage Unit)

The storage unit 30 is a data readable/writable storage device such as a dynamic random access memory (DRAM), a static random access memory (SRAM), a flash memory, or a hard disk. The storage unit 30 functions as storage means of the image processing apparatus 1. The storage unit 30 stores, for example, an image (for example, a luminance image) captured by the imaging unit 20, and a depth map generated by a map generation unit 420 and the like to be described later.

(Control Unit)

The control unit 40 is a controller that controls each unit of the image processing apparatus 1. The control unit 40 is realized by, for example, a processor such as a central processing unit (CPU), a micro processing unit (MPU), or a graphics processing unit (GPU). The control unit 40 may be configured to control an image processor that is outside the control unit 40 and executes image processing to be described later, or may be configured to execute image processing by itself. The function of the control unit 40 is realized, for example, by a processor executing various programs stored in a storage device inside the image processing apparatus 1 using a random access memory (RAM) or the like as a work area. Note that the control unit 40 may be realized by an integrated circuit such as an application specific integrated circuit (ASIC) or a field programmable gate array (FPGA). Any of the CPU, the MPU, the GPU, the ASIC, and the FPGA can be regarded as the controller.

The control unit 40 includes an acquisition unit 410, the map generation unit 420, a correction unit 430, and an output control unit 440, and realizes or executes a function and an action of information processing described below. Each block (the acquisition unit 410 to the output control unit 440) constituting the control unit 40 is a functional block indicating each function of the control unit 40. These functional blocks may be software blocks or hardware blocks. For example, each of the functional blocks described above may be one software module realized by software (including a microprogram) or one circuit block on a semiconductor chip (die). Each functional block may be one processor or one integrated circuit. A configuration method of the functional block is arbitrary. Note that the control unit 40 may be configured by a functional unit different from the above-described functional block.

(Acquisition Unit)

The acquisition unit 410 acquires various kinds of information. For example, the acquisition unit 410 acquires an image captured by the imaging unit 20. For example, the acquisition unit 410 acquires a multi-viewpoint image captured by the imaging unit 20. Note that the acquisition unit 410 may acquire an image captured by a monocular camera as a sensor. In this case, the acquisition unit 410 acquires the distance to the object, which is measured by a distance measurement sensor using, for example, a laser or the like. That is, the acquisition unit 410 may acquire not only a visible image but also image data including depth data as a captured image.

The acquisition unit 410 appropriately stores the acquired information in the storage unit 30. In addition, the acquisition unit 410 may appropriately acquire information required for processing from the storage unit 30, or may acquire information required for processing via the input/output unit 10. That is, the acquisition unit 410 does not necessarily acquire an image captured by the image processing apparatus 1, and may acquire an image captured by an external device, an image stored in advance in the storage unit 30, or the like.

(Map Generation Unit)

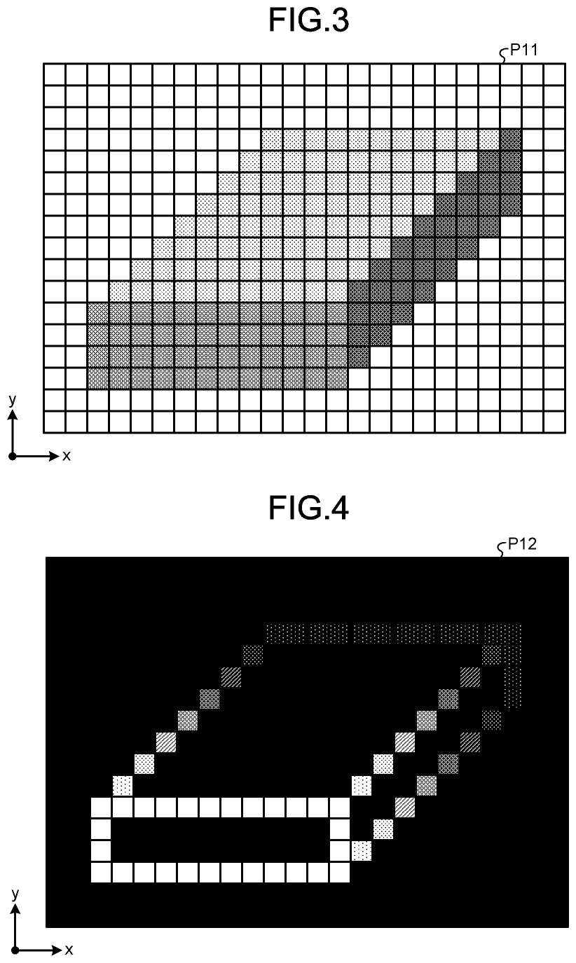

The map generation unit 420 generates a depth map on the basis of the multi-viewpoint image acquired by the acquisition unit 410. The map generation unit 420 generates a depth map by calculating a disparity value (disparity) of each pixel (or each region) on the basis of the multi-viewpoint image including a reference image P11 illustrated in FIG. 3. Note that FIG. 3 is a diagram illustrating an example of the reference image P11.

The map generation unit 420 generates a depth map on the basis of the comparison image (not illustrated) and the reference image P11 included in the multi-viewpoint image. The map generation unit 420 performs correlation processing with the comparison image using, for example, an upper left pixel area of the reference image P11 as a processing target pixel area, and calculates a disparity value of the processing target pixel area.

As the correlation processing, the map generation unit 420 calculates, for example, a correlation value between the processing target pixel area and a reference pixel area of the comparison image. Specifically, the map generation unit 420 sequentially calculates a correlation value with the processing target pixel area while sequentially moving the reference pixel area in the horizontal or vertical direction. Note that the moving direction of the reference pixel area is not limited to the horizontal or vertical direction, and may be any direction such as an oblique direction, for example.

The map generation unit 420 calculates a positional deviation (pixel shift) of the pixel area with the strongest correlation between the images as a phase difference (disparity value) on the basis of the calculated correlation value. Examples of the method of calculating the correlation value include the sum of absolute differences (SAD), the sum of squared differences (SSD), and the normalized cross-correlation (NCC).

Thereafter, the map generation unit 420 generates a depth map by performing correlation processing by sequentially shifting the processing target pixel area by one pixel in a raster scan direction and calculating a disparity value. Note that the pixel area is a region having an arbitrary shape, and may be one pixel or a region including a plurality of pixels.

Furthermore, for example, in a case where the imaging unit 20 is a multi-eye camera equipped with three or more cameras, the acquisition unit 410 acquires a multi-viewpoint image including a plurality of comparison images. In this case, the map generation unit 420 performs correlation processing between each comparison image and the reference image P11, and calculates a correlation value for each comparison image. The map generation unit 420 determines a correlation value with the strongest correlation among correlation values calculated for each comparison image. In a case where the determined correlation value is equal to or greater than the threshold, the map generation unit 420 determines the disparity value corresponding to the determined correlation value as the disparity value of the processing target pixel area.

On the other hand, in a case where the correlation value with the strongest correlation is smaller than the threshold, the map generation unit 420 determines that the disparity value of the processing target pixel area is invalid, and determines that the depth of the processing target pixel area is unknown. Note that the threshold used here is, for example, the minimum value of the correlation values when the correlation processing is performed on the same image. In this manner, the map generation unit 420 generates the depth map from the multi-viewpoint image captured by the multi-eye camera.

FIG. 4 illustrates an example of a depth map P12 generated by the map generation unit 420. FIG. 4 is a diagram illustrating an example of the depth map P12. In FIG. 4, the disparity value in each pixel of the reference image P11 (refer to FIG. 3) is illustrated as the depth map P12. Here, it is illustrated that the higher the luminance of the pixel, the larger the disparity value, and the lower the luminance, the smaller the disparity value. In addition, pixels with unknown depths are illustrated in black. In the example illustrated in FIG. 4, the map generation unit 420 can calculate the disparity value of the edge with high contrast of the reference image P11, but cannot calculate the disparity value of a region with low contrast such as a region in the plane surrounded by the edge of the subject, considering that the depth of the region is unknown. As described above, the map generation unit 420 cannot accurately calculate the depth of the pixel with low contrast, for example.

(Correction Unit)

Therefore, in the image processing apparatus 1 according to the first embodiment of the present disclosure, a disparity value of an unknown depth pixel is obtained by correcting the unknown depth pixel by the correction unit 430 illustrated in FIG. 2, and thereby the accuracy of the depth map P12 is improved. The correction unit 430 corrects the disparity value generated by the map generation unit 420 to calculate a corrected disparity value. Then, the correction unit 430 generates a corrected depth map on the basis of the corrected disparity value. As illustrated in FIG. 2, the correction unit 430 includes a pixel selection unit 431, a distance calculation unit 432, and a determination unit 433.

(Pixel Selection Unit)

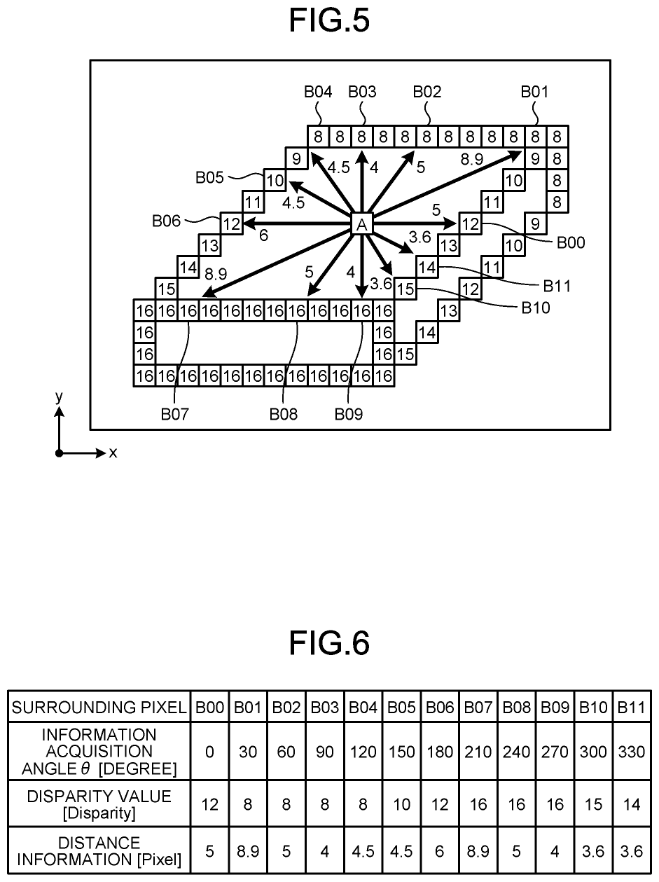

The pixel selection unit 431 selects a correction target pixel to be corrected, and at least one pixel (surrounding pixel) around the correction target pixel. First, the pixel selection unit 431 selects, for example, an unknown depth pixel having an invalid disparity value, from the depth map P12 as the correction target pixel A. As illustrated in FIG. 5, the pixel selection unit 431 selects, for example, an unknown depth pixel surrounded by pixels having depth information (hereinafter, also referred to as a depth valid pixel), as the correction target pixel A. Note that FIG. 5 is a diagram for describing selection of a pixel by the pixel selection unit 431. In FIG. 5, the disparity value of each pixel is indicated by a numerical value in the pixel, and the unknown depth pixel is illustrated in white.

Subsequently, the pixel selection unit 431 selects a plurality of surrounding pixels around the correction target pixel A, from among the depth valid pixels as reference pixels. For example, the pixel selection unit 431 selects a plurality of surrounding pixels at predetermined angular intervals, from among the depth valid pixels surrounding the periphery of the correction target pixel A. In the example of FIG. 5, the pixel selection unit 431 selects 12 surrounding pixels B00 to B11 at equal intervals of 30 degrees, from the entire periphery of the correction target pixel A.

In the example illustrated in FIG. 5, the pixel selection unit 431 selects the depth valid pixel located in the positive direction of the x axis starting from the correction target pixel A, as the surrounding pixel B00. In addition, the pixel selection unit 431 selects the depth valid pixel located in a direction rotated by 30 degrees from the positive direction of the x axis starting from the correction target pixel A, as the surrounding pixel B01. As described above, the pixel selection unit 431 selects the depth valid pixels located in directions rotated by every 30 degrees from the positive direction of the x axis starting from the correction target pixel A, as the surrounding pixels B00 to B11. Note that the surrounding pixels B00 to B11 illustrated in FIG. 5 are examples, and the pixel selection unit 431 may select at least one depth valid pixel around the correction target pixel A. In addition, the pixel selection unit 431 does not necessarily select the surrounding pixels B00 to B11 at equal intervals, and the equal interval may not be 30 degrees. Note that, hereinafter, in a case where it is not necessary to distinguish the components of the surrounding pixels B00 to B11 from each other, the identification numbers at the ends of the reference numerals of the components of the surrounding pixels B00 to B11 are omitted.

FIG. 6 illustrates information regarding the surrounding pixels B selected by the pixel selection unit 431. FIG. 6 is a table illustrating each piece of information of the surrounding pixels B. FIG. 6 illustrates an information acquisition angle θ, the disparity value (Disparity), and the distance information (Pixel) of the surrounding pixels B. The information acquisition angle θ indicates an angle formed by a line segment connecting the correction target pixel A and the surrounding pixels B and the x axis. In addition, the disparity value indicates the disparity value of the surrounding pixel B. The distance information indicates a distance between the correction target pixel A and the surrounding pixel B.

(Distance Calculation Unit)

Returning to FIG. 2, the distance calculation unit 432 calculates the total value of the distances in the subject space between the correction target pixel A and the surrounding pixels B selected by the pixel selection unit 431. At this time, the distance calculation unit 432 calculates the total value while changing the disparity value of the correction target pixel A, in other words, the depth in the subject space.

Hereinafter, a method of calculating the total value of the distances in the subject space between the correction target pixel A and the surrounding pixels B by the distance calculation unit 432 will be described.

Assuming that the coordinates of the correction target pixel A on the reference image P11 are (xₐ, yₐ) and the distance information of the surrounding pixel B corresponding to the information acquisition angle θ is Lₛ(θ), the coordinates (xₛ(θ), yₛ(θ)) of the surrounding pixel B on the reference image P11 can be obtained from (Equation 1) and (Equation 2).

[Math 1]

xₛ(θ)=Lₛ(θ)cos θ+xₐ (Equation 1)

yₛ(θ)=Lₛ(θ)sin θ+Yₐ (Equation 2)

In addition, in a case where the disparity value (disparity) of arbitrary coordinates (x, y) on the reference image P11 is D, the arbitrary coordinates (x, y) of the reference image P11 can be coordinate-transformed into coordinates (X, Y, Z) of the subject space by using (Equation 3) to (Equation 5). Note that X_{org} and Y_{org} are optical axis center coordinates on the reference image P11, and a and b are coefficients for the coordinate transformation from the reference image P11 into the subject space.

[Math 2]

X=a(x−X_{org})/D (Equation 3)

Y=a(y−Y_{org})/D (Equation 4)

Z=b/D (Equation 5)

It is assumed that when the disparity value (disparity) of the correction target pixel A is d, the coordinates in the subject space are (Xₐ(d), Yₐ(d), Zₐ(d)), and the coordinates of the surrounding pixel B corresponding to the information acquisition angle θ in the subject space are (Xₛ(θ), Yₛ(θ), Zₛ(θ)). In this case, a distance L (d, θ) between the correction target pixel A and the surrounding pixel B in the subject space can be obtained from (Equation 6).

[Math 3]

L(d,θ)={square root over ((Xₐ(d)−Xₛ(θ))²+(Yₐ(d)−Yₛ(θ))²+(Zₐ(d)−Zₛ(θ))²)} (Equation 6)

Therefore, for example, in a case where the interval of the information acquisition angle θ is 30 degrees and the number of surrounding pixels B is 12, the total value Lₜₒₜₐₗ(d) of the distances L(d, θ) between the correction target pixel A and the surrounding pixels B in the subject space can be calculated on the basis of (Equation 7).

[Math 4]

Lₜₒₜₐₗ(d)=Σᵢ₌₀¹¹L(d,30i) (Equation 7)

The distance calculation unit 432 calculates the total value Lₜₒₜₐₗ(d) of the distance L(d, θ) while changing the disparity value (disparity) d of the correction target pixel A within a predetermined range on the basis of (Equation 1) to (Equation 7) described above. Note that the predetermined range used here is, for example, a range of disparity values included in the depth map P12. As described above, for example, the distance calculation unit 432 calculates the total value Lₜₒₜₐₗ(d) while changing the disparity value d of the correction target pixel A in a range from the minimum value to the maximum value of the disparity values included in the depth map P12 generated by the map generation unit 420.

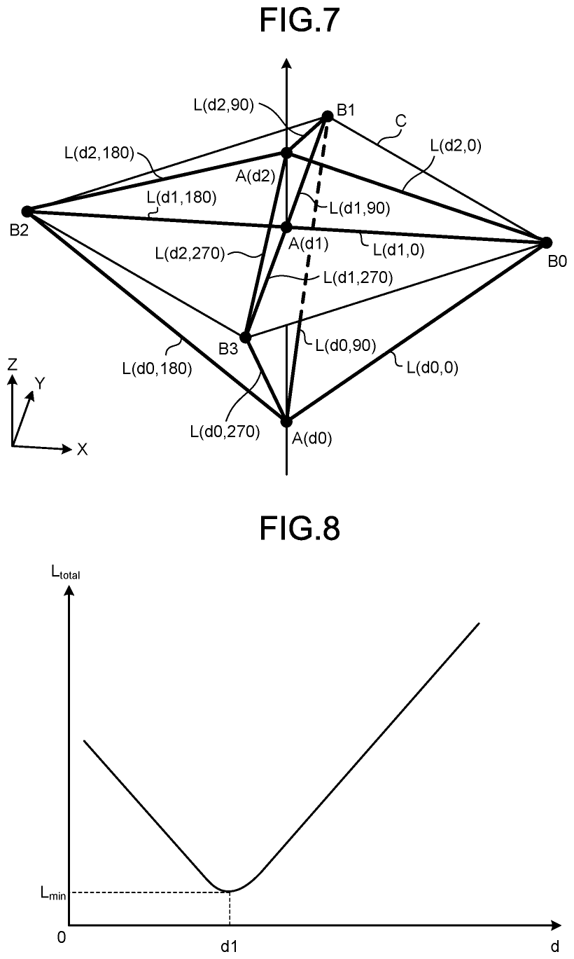

Next, the total value Lₜₒₜₐₗ(d) in a case where the disparity value d of the correction target pixel A is changed will be described with reference to FIG. 7. FIG. 7 is a diagram for describing the total value Lₜₒₜₐₗ(d) in a case where the disparity value d of the correction target pixel A is changed.

Note that, in FIG. 7, in order to simplify the description, the number of surrounding pixels B is four, that is, the interval of the information acquisition angle θ is set to 90 degrees. In addition, here, a description will be given by defining coordinate axes with the upward direction in FIG. 7 as the Z-axis direction.

As illustrated in FIG. 7, it is assumed that the disparity value d of the correction target pixel A is changed from d0 to d2. Note that the disparity value in a case where the correction target pixel A is located on a plane P formed by the surrounding pixels B0 to B3 is d1, and the disparity value in a case where the correction target pixel A is closer to the front side than the plane P, that is, is on the negative direction of the Z axis is d0. In addition, the disparity value in a case where the correction target pixel A is closer to the rear side than the plane P, that is, is on the positive direction of the Z axis is d2.

Furthermore, the distance between the correction target pixel A(d0) with the disparity value d0 and the correction target pixel A(d1) with the disparity value d1 is longer than the distance between the correction target pixel A(d1) with the disparity value d1 and the correction target pixel A(d2) with the disparity value d2.

In this case, the distance L(d, θ) between the correction target pixel A and the surrounding pixel B is the longest in the case of the disparity value d0, and is the shortest in the case of the disparity value d1. In other words, in a case where the correction target pixel A is on the plane P, the distance L(d, θ) is the shortest, and the distance L(d, θ) is increased as the correction target pixel A is farther from the plane P. Therefore, the total value Lₜₒₜₐₗ(d) of the distances L(d, θ) is also the shortest when the correction target pixel A is on the plane P, and is increased as the correction target pixel A is farther from the plane P.

FIG. 8 illustrates a change of the value of the total value Lₜₒₜₐₗ in a case where the disparity value d of the correction target pixel A is changed. FIG. 8 is a graph illustrating an example of a relationship between the disparity value d of the correction target pixel A and the total value Lₜₒₜₐₗ.

As illustrated in FIG. 8, in a case where the disparity value d of the correction target pixel A is changed, the total value Lₜₒₜₐₗ becomes the minimum value Lₘᵢₙ at the disparity value d1. As described above, when the disparity value d of the correction target pixel A is changed, the total value Lₜₒₜₐₗ is bent downward, that is, is changed by drawing a downward convex trajectory.

(Determination Unit)

Returning to FIG. 2, the determination unit 433 determines the disparity value d of the correction target pixel A on the basis of the total value Lₜₒₜₐₗ calculated by the distance calculation unit 432, and corrects the depth map P12 using the determined disparity value d.

As described above, it is considered that the unknown depth pixel surrounded by the depth valid pixels is located on a plane including the depth valid pixels. In other words, it is considered that the correction target pixel A is located on the same plane as the surrounding pixels B. Therefore, the determination unit 433 determines the disparity value d of the correction target pixel A on the assumption that the correction target pixel A is located on the same plane as the surrounding pixels B.

As described with reference to FIG. 8, when the disparity value d of the correction target pixel A is changed, the total value Lₜₒₜₐₗ of the distances L between the correction target pixel A and the surrounding pixels B in the subject space is changed while drawing a trajectory bent downward at a position where the correction target pixel A is located on the same plane as the surrounding pixels B. Therefore, the determination unit 433 extracts a point (bending point) at which the trajectory of change of the total value Lₜₒₜₐₗ is bent, and determines the disparity value d at the extracted bending point as the disparity value d of the correction target pixel A. Specifically, for example, the determination unit 433 corrects the depth map P12 by determining the disparity value d1 (refer to FIGS. 7 and 8) at which the total value Lₜₒₜₐₗ (d) becomes the minimum value Lₘᵢₙ as the disparity value d of the correction target pixel A.

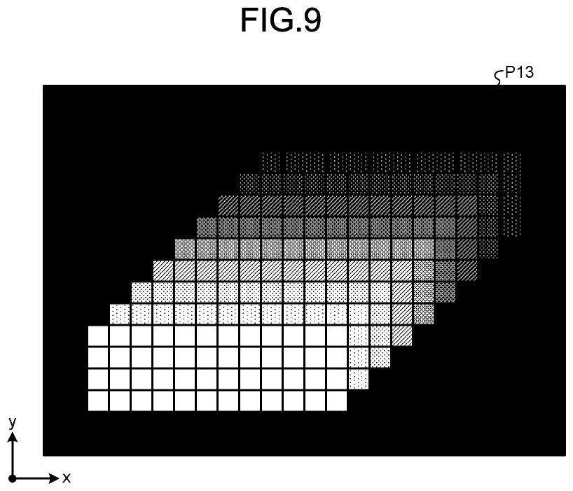

The correction unit 430 illustrated in FIG. 2 determines the disparity value d for all the unknown depth pixels surrounded by the depth valid pixels, and corrects the depth map P12 to generate a corrected depth map P13. Here, FIG. 9 illustrates the corrected depth map P13 generated by the correction unit 430. FIG. 9 is a diagram illustrating an example of the corrected depth map P13.

As illustrated in FIG. 9, a pixel of which the depth is unknown in the depth map P12 (refer to FIG. 4) can also be the depth valid pixel by correcting the disparity value. As described above, the correction unit 430 corrects the unknown depth pixels, so that the calculation accuracy of the depth of the reference image P11 can be improved.

(Output Control Unit)

Returning to FIG. 2, the output control unit 440 controls the input/output unit 10 to output the corrected depth map P13. The output control unit 440 displays the corrected depth map P13 on a display (not illustrated) or the like via the input/output unit 10, for example. Alternatively, the output control unit 440 may output the corrected depth map P13 to an external device such as a storage device, for example. When the output of the corrected depth map P13 is completed, the correction unit 430 completes the correction processing of the depth map P12.

### 1-3. Procedure of Information Processing According to First Embodiment

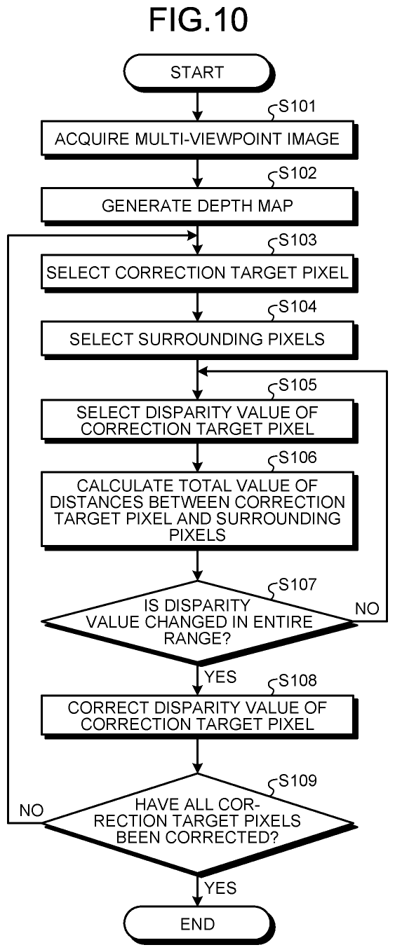

Next, a procedure of image processing according to the first embodiment of the present disclosure will be described with reference to FIG. 10. FIG. 10 is a flowchart illustrating a flow of processing according to the first embodiment of the present disclosure.

As illustrated in FIG. 10, the image processing apparatus 1 acquires a multi-viewpoint image (step S101). The multi-viewpoint image may be acquired using the imaging unit 20, or may be acquired from another sensor, an external device, or the like. Then, the image processing apparatus 1 generates the depth map P12 from the multi-viewpoint image (step S102).

Subsequently, the image processing apparatus 1 selects the unknown depth pixel from the generated depth map P12 as the correction target pixel A (step S103). Thereafter, the image processing apparatus 1 selects the depth valid pixels around the correction target pixel A as the surrounding pixels B (step S104).

The image processing apparatus 1 selects the disparity value d of the correction target pixel A from a predetermined range (step S105), and calculates the total value Lₜₒₜₐₗ of the distances L between the correction target pixel A and the surrounding pixels B in the subject space (step S106).

In a case where the disparity value d of the correction target pixel A is changed in the entire predetermined range (step S107; Yes), the image processing apparatus 1 corrects the disparity value d of the correction target pixel A with the disparity value d1 corresponding to the minimum value Lₘᵢₙ of the total value Lₜₒₜₐₗ in a case where the disparity value d of the correction target pixel A is changed (step S108).

On the other hand, in a case where there is a disparity value d that has not been changed in the predetermined range (step S107; No), the image processing apparatus 1 returns to step S105 and selects the disparity value d that has not been changed.

Subsequently, the image processing apparatus 1 that has corrected the disparity value d in step S108 determines whether or not all the correction target pixels A have been corrected (step S109). In a case where all the correction target pixels A have been corrected (step S109; Yes), the image processing apparatus 1 ends the processing. On the other hand, in a case where there is a correction target pixel A that has not been corrected (step S109; No), the image processing apparatus 1 returns to step S103 and corrects the correction target pixel A that has not been corrected.

According to the present embodiment, the image processing apparatus 1 selects a correction target region (here, the correction target pixel A) and a reference region (here, the surrounding pixels B) around the correction target region on the basis of the depth map P12 relating to depth information (here, the disparity value d) of the subject space. The image processing apparatus 1 corrects the depth information on the basis of the distance L between the correction target region and the reference region in the subject space. Note that, in the present embodiment, since a plurality of reference regions are selected, the depth information is corrected on the basis of the total value Lₜₒₜₐₗ of the distances L. As a result, the image processing apparatus 1 can correct the depth information of the unknown depth pixel, and can improve the calculation accuracy of the depth.

### 2. Second Embodiment

### 2-1. Configuration of Information Processing Apparatus According to Second Embodiment

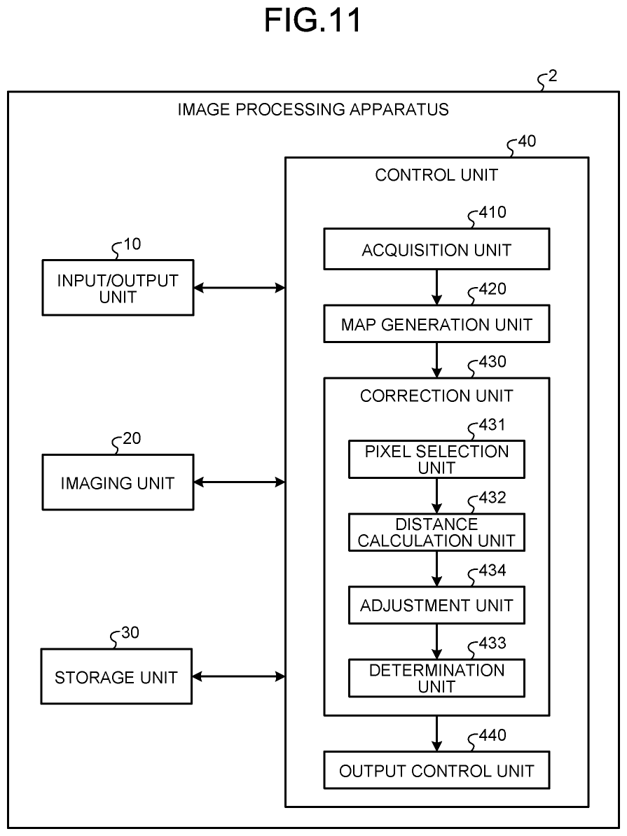

A configuration example of an image processing apparatus 2 according to a second embodiment of the present disclosure will be described with reference to FIG. 11. FIG. 11 is a diagram illustrating a configuration example of the image processing apparatus 2 according to the second embodiment of the present disclosure. Note that, in the following description, the same configuration as that of the first embodiment is cited, and redundant description thereof will be omitted.

As illustrated in FIG. 11, the correction unit 430 of the image processing apparatus 2 according to the embodiment of the present disclosure further includes an adjustment unit 434. The adjustment unit 434 adjusts (corrects) a calculation result of the distance calculation unit 432.

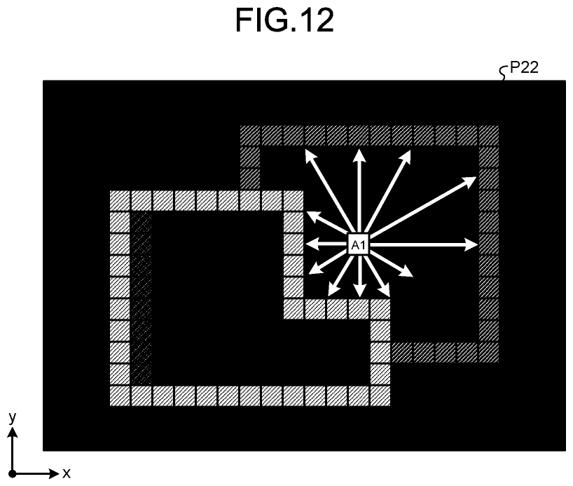

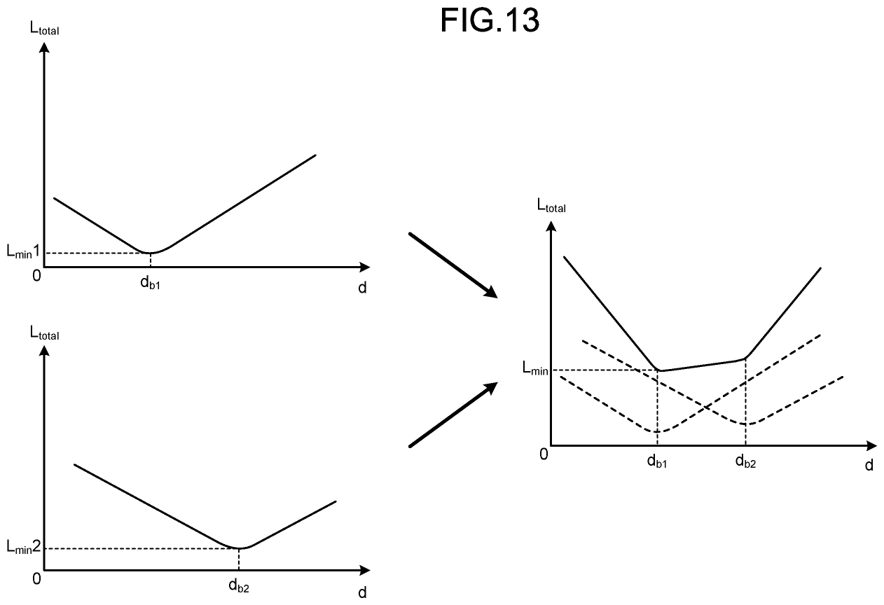

Here, the reason why the adjustment unit 434 performs adjustment will be described with reference to FIGS. 12 and 13. FIG. 12 is a diagram (1) for describing the reason why the adjustment unit 434 performs adjustment. FIG. 13 is a diagram (2) for describing the reason why the adjustment unit 434 performs adjustment.

As illustrated in FIG. 12, in a case where there are two planes having different depths in the subject space, a depth map P22 may be generated in a state where the two planes overlap each other. In this case, for example, while all the edges of the front-side plane are extracted, a part of the back-side plane is hidden behind the front-side plane so that a part of the edges may not be extracted.

In this case, as illustrated in FIG. 12, it is assumed that the pixel selection unit 431 selects an unknown depth pixel located on the back-side plane as a correction target pixel A1, and selects surrounding pixels of the correction target pixel A1. At this time, a plurality of surrounding pixels selected by the pixel selection unit 431 include not only the edge pixel of the back-side plane but also the edge pixel of the front-side plane.

In this state, when the distance calculation unit 432 calculates the total value Lₜₒₜₐₗ of the distances L between the correction target pixel A1 and the surrounding pixels B while changing the disparity value d of the correction target pixel A1, the trajectory of the total value Lₜₒₜₐₗ is affected by both the front and back planes. Specifically, as illustrated in the graph on the right side of FIG. 13, the trajectory of the total value Lₜₒₜₐₗ is a graph bent at two points of disparity values d_{b1} and d_{b2}. As described above, the trajectory of the total value Lₜₒₜₐₗ is a graph having two bending points.

This is because the total value Lₜₒₜₐₗ calculated by the distance calculation unit 432 includes both the distance component to the edge pixel of the front-side plane and the distance component to the edge pixel of the back-side plane. For example, as illustrated in the upper left graph of FIG. 13, the distance component to the edge pixel of the front-side plane becomes the minimum value Lₘᵢₙ1 when the correction target pixel A1 is located on the front-side plane. On the other hand, as illustrated in the lower left graph of FIG. 13, the distance component to the edge pixel of the back-side plane becomes the minimum value Lₘᵢₙ2 when the correction target pixel A1 is located on the back-side plane. Therefore, as illustrated in the graph on the right side of FIG. 13, the total value Lₜₒₜₐₗ calculated by the distance calculation unit 432 draws a trajectory bent at two points in a case where the correction target pixel A1 is located on the front-side plane and in a case where the correction target pixel A1 is located on the back-side plane.

Here, when the disparity value d at which the total value Lₜₒₜₐₗ is minimum is set as the correction value of the correction target pixel A1, the determination unit 433 may perform correction assuming that the correction target pixel A1 belongs to the front-side plane as illustrated in the graph on the right side of FIG. 13, for example.

However, in a case where there are a plurality of bending points in the trajectory of the total value Lₜₒₜₐₗ, that is, in a case where the surrounding pixels include not only the pixel of the back-side plane but also the pixel of the front-side plane, it is considered that the correction target pixel A1 belongs to the back-side plane (refer to FIG. 12). As described above, when the correction of the correction target pixel A1 is performed according to the minimum value of the total value Lₜₒₜₐₗ, there is a possibility that the determination unit 433 erroneously corrects the correction target pixel A1.

Therefore, in the image processing apparatus 2 according to the second embodiment of the present disclosure, the adjustment unit 434 adjusts the total value Lₜₒₜₐₗ so that the determination unit 433 can correct the correction target pixel A1 assuming that the correction target pixel A1 is on the back-side plane.

In a case where there are a plurality of bending points, the adjustment unit 434 adjusts the total value Lₜₒₜₐₗ so that the bending point can be extracted from the back side, that is, from a side where the depth is deep. Specifically, the adjustment unit 434 corrects the total value Lₜₒₜₐₗ by subtracting a correction function C(d) from the total value Lₜₒₜₐₗ.

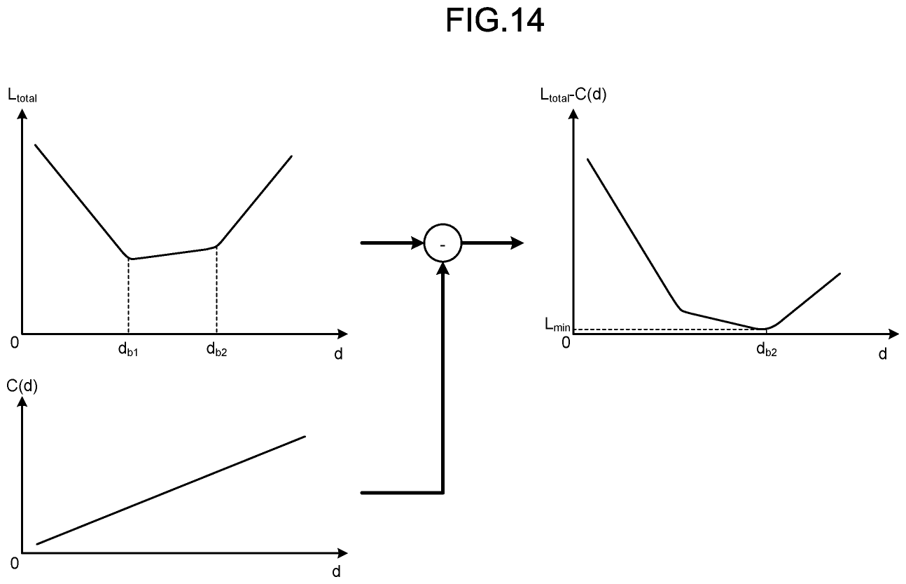

As illustrated in FIG. 14, the adjustment unit 434 corrects the trajectory of the total value Lₜₒₜₐₗ such that the bending point on the back side becomes the minimum value by subtracting the correction function C(d), which is a straight line of an inclination k, from the total value Lₜₒₜₐₗ FIG. 14 is a diagram for describing an adjustment method by the adjustment unit 434. In FIG. 14, the correction function C(d) is a straight line having an inclination of k, but the correction function C(d) is not limited thereto. Note that the correction function C(d) may be any function as long as the trajectory of the total value Lₜₒₜₐₗ can be adjusted such that the bending point on the back side becomes the minimum value. It is assumed that the correction function C(d) is obtained in advance by, for example, a simulation, an experiment, or the like.

### 2-2. Procedure of Information Processing According to Second Embodiment

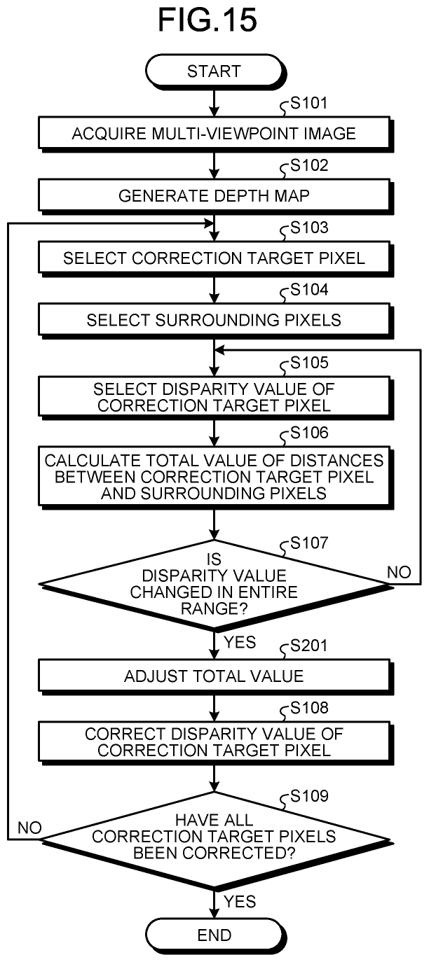

Next, a procedure of image processing according to the second embodiment of the present disclosure will be described with reference to FIG. 15. FIG. 15 is a flowchart illustrating a flow of processing according to the second embodiment of the present disclosure. Note that, in the processing of FIG. 15, the description of the same processing as the processing of FIG. 10 is omitted.

The image processing apparatus 2 that has calculated the total value Lₜₒₜₐₗ of the distances L by changing the disparity value d in the entire predetermined range (step S107; Yes) adjusts the calculated total value Lₜₒₜₐₗ (step S201). Specifically, the total value Lₜₒₜₐₗ is adjusted by subtracting a value corresponding to the correction function C(d) from the total value Lₜₒₜₐₗ Thereafter, the image processing apparatus 2 corrects the disparity value d of the correction target pixel A1 with the disparity value d_{b2} corresponding to the minimum value Lₘᵢₙ of the total value Lₜₒₜₐₗ in a case where the disparity value d of the correction target pixel A1 is changed (step S108).

As described above, in a case where the total value Lₜₒₜₐₗ includes a plurality of bending points, the image processing apparatus 2 extracts the bending point corresponding to the back-side plane, and corrects the disparity value d of the correction target pixel A1 with the disparity value d_{b2} corresponding to the extracted bending point. As a result, the image processing apparatus 2 can correct the depth information of the unknown depth pixel, and can improve the calculation accuracy of the depth.

In addition, the adjustment unit 434 of the image processing apparatus 2 adjusts (corrects) the total value using the correction function C(d). As a result, the determination unit 433 can correct the correction target pixel A1 by extracting the minimum value of the adjusted total value Lₜₒₜₐₗ The processing of correcting the total value Lₜₒₜₐₗ using the correction function C(d) has a lighter processing load than the processing of checking the number of planes included in the depth map P22 or separating a plurality of planes. Therefore, the image processing apparatus 2 can accurately correct the depth information of the unknown depth pixel without increasing the processing load.

### 3. Other Configuration Examples

Each of the above-described embodiments is an example, and various modifications and applications are possible.

For example, in each of the above-described embodiments, the image processing apparatus 1 or 2 generates a depth map (corrected depth map) by using a still image as an input. However, the image processing apparatus 1 or 2 may generate a depth map (corrected depth map) by using a moving image as an input.

Furthermore, in each of the above-described embodiments, the image processing apparatus 1 or 2 corrects the depth map generated from the multi-viewpoint image captured by the multi-eye camera. However, the image processing apparatus 1 or 2 may correct a detection result of a distance measurement sensor that measures a distance to a subject, such as a time of flight (ToF) sensor.

In this case, the image processing apparatus 1 or 2 may correct the depth information that cannot be detected by the distance measurement sensor. Alternatively, the detection result may be corrected by calculating the depth information between a region where the depth is detected by the distance measurement sensor and a region. Thus, the image processing apparatus 1 or 2 can improve the resolution of the detection result.

Furthermore, in each of the above-described embodiments, the image processing apparatus 1 or 2 calculates the disparity value (disparity) as the depth information. However, the image processing apparatus 1 or 2 may calculate, for example, coordinates in the subject space coordinates and an actual distance (depth) to the subject.

Furthermore, among the processing described in each of the above-described embodiments, all or a part of the processing described as being automatically performed can be manually performed, or all or a part of the processing described as being manually performed can be automatically performed by a known method. In addition, the processing procedure, specific name, and information including various kinds of data and parameters illustrated in the document and the drawings can be arbitrarily changed unless otherwise specified. For example, the various kinds of information illustrated in the drawings are not limited to the illustrated information.

In addition, each component of each apparatus illustrated in the drawings is functionally conceptual, and is not necessarily physically configured as illustrated in the drawings. That is, a specific form of distribution and integration of each apparatus is not limited to the illustrated form, and all or a part thereof can be functionally or physically distributed and integrated in an arbitrary unit according to various loads, usage conditions, and the like.

In addition, the above-described embodiments can be appropriately combined within a range in which the processing contents do not contradict each other. Furthermore, the image processing apparatuses 1 and 2 may be a cloud server or the like that acquires information via a network and determines a removal range on the basis of the acquired information.

Furthermore, the effects described in the present specification are merely examples and are not limited, and other effects may be provided.

### 4. Effects of Information Processing Apparatus According to Present Disclosure

As described above, the information processing apparatus (in the first and second embodiments, the image processing apparatuses 1 and 2) according to the present disclosure includes the control unit (in the first and second embodiments, the control unit 40). The control unit selects a correction target region (in the first and second embodiments, the correction target pixels A and A1) and a reference region (in first and second embodiments, the surrounding pixel B) around the correction target region on the basis of a depth map (in the first and second embodiments, the depth maps P12 and P22) relating to depth information (in the first and second embodiments, the disparity value d) of a subject space. In addition, the control unit corrects depth information of the correction target region on the basis of a distance (in the first and second embodiments, the total value Lₜₒₜₐₗ of the distances L) between the correction target region and the reference region in the subject space. As a result, the information processing apparatus can improve the calculation accuracy of the depth information.

Furthermore, the control unit corrects the depth information of the correction target region on the basis of a change of the distance when the depth (in the first and second embodiments, the disparity value d) of the correction target region is changed. As described above, the information processing apparatus can correct the depth information of the correction target region by changing the depth of the correction target region, and can improve the calculation accuracy of the depth information.

The control unit determines the depth of the correction target region corresponding to the bending point on the trajectory of the distance when the depth of the correction target region is changed, as the corrected depth of the correction target region. In this manner, the information processing apparatus can correct the depth information of the correction target region by extracting the bending point, and can improve the calculation accuracy of the depth information.

The control unit determines the deepest depth among the depths of the plurality of correction target regions respectively corresponding to the plurality of bending points, as the corrected depth of the correction target region. As a result, the information processing apparatus can improve the calculation accuracy of the depth information even in a case where the depth map includes a plurality of planes.

The control unit determines the depth of the correction target region when the distance is minimum, as the corrected depth of the correction target region. As a result, the information processing apparatus can correct the depth information of the correction target region, and can improve the calculation accuracy of the depth information.

The control unit corrects the distance, and corrects the depth information of the correction target region on the basis of the corrected distance. As a result, the information processing apparatus can improve the calculation accuracy of the depth information without increasing the processing load even in a case where the depth map includes a plurality of planes.

The control unit selects a region (in first and second embodiments, the unknown depth pixel) in which the calculation accuracy of the depth information is equal to or less than a predetermined threshold as the correction target region, and selects a region in which the calculation accuracy of the depth information is larger than the predetermined threshold as the reference region. The information processing apparatus can correct the depth information of the region in which the calculation accuracy of the depth information is equal to or less than the predetermined threshold, and can improve the calculation accuracy of the depth information.

### 5. Hardware Configuration

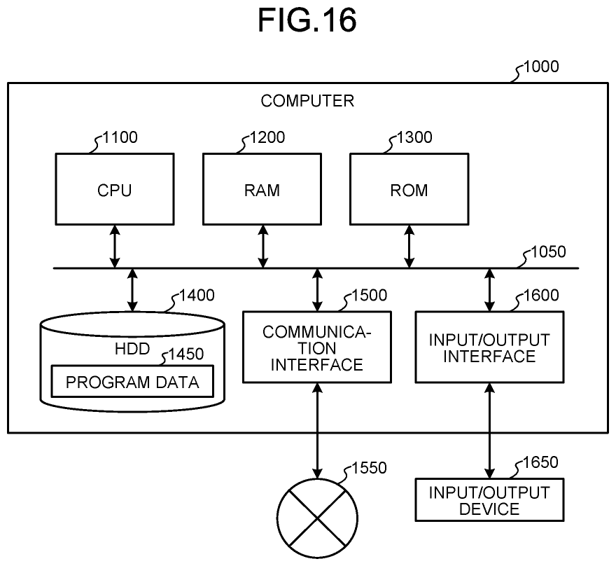

An information device such as the image processing apparatus 1 according to each of the above-described embodiments is realized by, for example, a computer 1000 having a configuration as illustrated in FIG. 16. Hereinafter, the image processing apparatus 1 according to the embodiment will be described as an example. FIG. 16 is a hardware configuration diagram illustrating an example of the computer 1000 that implements the functions of the image processing apparatus 1. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-temporarily records a program executed by the CPU 1100, data used by the program, and the like. Specifically, the HDD 1400 is a recording medium that records the information processing program according to the present disclosure, which is an example of program data 1450.

The communication interface 1500 is an interface for connecting the computer 1000 to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the image processing apparatus 1 according to the embodiment, the CPU 1100 of the computer 1000 realizes the functions of the control unit 40 and the like by executing the information processing program loaded on the RAM 1200. In addition, the HDD 1400 stores the image processing program according to the present disclosure and data in the storage unit 30. Note that the CPU 1100 executes the program data 1450 by reading the program data 1450 from the HDD 1400, but as another example, may acquire these programs from another device via the external network 1550.

Note that the present technology can also have the following configurations.

(1)

An information processing apparatus comprising:

a control unit that selects a correction target region and a reference region around the correction target region on the basis of a depth map relating to depth information of a subject space, and

corrects the depth information of the correction target region on the basis of a distance between the correction target region and the reference region in the subject space.

(2)

The information processing apparatus according to (1), wherein the control unit corrects the depth information of the correction target region on the basis of a change of the distance when a depth of the correction target region is changed.

(3)

The information processing apparatus according to (2), wherein the control unit determines the depth of the correction target region corresponding to a bending point of a trajectory of the distance when the depth of the correction target region is changed, as the corrected depth of the correction target region.

(4)

The information processing apparatus according to (3), wherein the control unit determines a deepest depth among depths of a plurality of the correction target regions respectively corresponding to a plurality of the bending points, as the corrected depth of the correction target region.

(5)

The information processing apparatus according to any one of (2) to (4), wherein the control unit determines the depth of the correction target region when the distance is minimum, as the corrected depth of the correction target region.

(6)

The information processing apparatus according to any one of (1) to (5), wherein the control unit corrects the distance, and corrects the depth information of the correction target region on the basis of the corrected distance.

(7)

The information processing apparatus according to any one of (1) to (6), wherein the control unit selects a plurality of reference regions surrounding the correction target region, and corrects the depth information of the correction target region on the basis of a total value of distances between the correction target region and the plurality of reference regions.

(8)

The information processing apparatus according to any one of (1) to (7), wherein the control unit selects a region in which a calculation accuracy of the depth information is equal to or less than a predetermined threshold, as the correction target region, and selects a region in which the calculation accuracy of the depth information is larger than the predetermined threshold, as the reference region.

(9)

An information processing method, by a computer, comprising:

selecting a correction target region and a reference region around the correction target region on the basis of a depth map relating to depth information of a subject space; and

correcting the depth information of the correction target region on the basis of a distance between the correction target region and the reference region in the subject space.

(10)

An information processing program causing a computer to function as:

a control unit that selects a correction target region and a reference region around the correction target region on the basis of a depth map relating to depth information of a subject space, and

corrects the depth information of the correction target region on the basis of a distance between the correction target region and the reference region in the subject space.

### REFERENCE SIGNS LIST

1, 2 IMAGE PROCESSING APPARATUS
10 INPUT/OUTPUT UNIT
20 IMAGING UNIT
30 STORAGE UNIT
40 CONTROL UNIT
410 ACQUISITION UNIT
420 MAP GENERATION UNIT
430 CORRECTION UNIT
431 PIXEL SELECTION UNIT
432 DISTANCE CALCULATION UNIT
433 DETERMINATION UNIT
434 ADJUSTMENT UNIT
440 OUTPUT CONTROL UNIT

1. An information processing apparatus comprising:
a control unit that selects a correction target region and a reference region around the correction target region on the basis of a depth map relating to depth information of a subject space, and
corrects the depth information of the correction target region on the basis of a distance between the correction target region and the reference region in the subject space.

2. The information processing apparatus according to claim 1, wherein the control unit corrects the depth information of the correction target region on the basis of a change of the distance when a depth of the correction target region is changed.

3. The information processing apparatus according to claim 2,
wherein the control unit
determines the depth of the correction target region corresponding to a bending point of a trajectory of the distance when the depth of the correction target region is changed, as the corrected depth of the correction target region.

4. The information processing apparatus according to claim 3, wherein the control unit determines a deepest depth among depths of a plurality of the correction target regions respectively corresponding to a plurality of the bending points, as the corrected depth of the correction target region.

5. The information processing apparatus according to claim 2, wherein the control unit determines the depth of the correction target region when the distance is minimum, as the corrected depth of the correction target region.

6. The information processing apparatus according to claim 5,
wherein the control unit
corrects the distance, and
corrects the depth information of the correction target region on the basis of the corrected distance.

7. The information processing apparatus according to claim 6, wherein the control unit selects a plurality of reference regions surrounding the correction target region, and corrects the depth information of the correction target region on the basis of a total value of distances between the correction target region and the plurality of reference regions.

8. The information processing apparatus according to claim 7, wherein the control unit selects a region in which a calculation accuracy of the depth information is equal to or less than a predetermined threshold, as the correction target region, and selects a region in which the calculation accuracy of the depth information is larger than the predetermined threshold, as the reference region.

9. An information processing method, by a computer, comprising:
selecting a correction target region and a reference region around the correction target region on the basis of a depth map relating to depth information of a subject space; and
correcting the depth information of the correction target region on the basis of a distance between the correction target region and the reference region in the subject space.

10. An information processing program causing a computer to function as:
a control unit that selects a correction target region and a reference region around the correction target region on the basis of a depth map relating to depth information of a subject space, and
corrects the depth information of the correction target region on the basis of a distance between the correction target region and the reference region in the subject space.
